(19) United States
(12) Patent Application Publication
(10) Pub. No.: US 2008/0163891 A1
(43) Pub. Date: Jul. 10, 2008

(54) METHOD AND APPARATUS OF MULTI STEPS ATOMIZATION FOR GENERATING SMALLER DIW DROPPLETS FOR WAFER CLEANING

(75) Inventors: JIANSHE TANG, San Jose, CA (US); Wei Lu, Fremont, CA (US); Bo Xie, Sunnyvale, CA (US); Elias Martinez, Belmont, CA (US); Zhiyong Li, San Jose, CA (US); Kent Child, Los Banos, CA (US); Richard Endo, San Carlos, CA (US); Konstantin Smekalin, Pleasanton, CA (US)

Correspondence Address: APPLIED MATERIALS/BLAKELY, 1279 OAKMEAD PARKWAY, SUNNYVALE, CA, 94085-4040, US

(73) Assignee: APPLIED MATERIALS, INC.

(21) Appl. No.: 11/621,855

(22) Filed: Jan. 10, 2007

(51) Int. Cl. B08B 3/00

(52) U.S. Cl. 134/1.3; 134/198

(57) ABSTRACT

An apparatus for cleaning a wafer has a first chamber and a component coupled to the first chamber. The first chamber has a first input to form de-ionized water droplets. The component is coupled to the first chamber to further atomize and apply the atomized de-ionized water droplets on the wafer.

### TECHNICAL FIELD

This invention relates to the field of wafer cleaning and, in particular, to deionized water droplets for wafer cleaning.

### BACKGROUND

For fabrication of semiconductor devices, thin slices or wafers of semiconductor material require polishing by a process that applies an abrasive slurry to the wafer's surfaces. After polishing, slurry residue is generally cleaned or scrubbed from the wafer surfaces via mechanical scrubbing devices. A similar polishing step is performed to planarize dielectric or metal films during subsequent device processing on the semiconductor wafer.

After polishing, be it during wafer or device processing, slurry residue conventionally is cleaned from wafer surfaces by submersing the wafer into a tank of sonically energized cleaning fluid, by spraying with sonically energized cleaning or rinsing fluid, by mechanically cleaning the wafer in a scrubbing device which employs brushes, such as polyvinyl acetate (PVA) brushes, or by a combination of the foregoing.

Although these conventional cleaning devices remove a substantial portion of the slurry residue which adheres to the wafer surfaces, slurry particles nonetheless remain and may produce defects during subsequent processing. Specifically, subsequent processing has been found to redistribute slurry residue from the wafer's edges to the front of the wafer, causing defects. Furthermore, these conventional cleaning devices may cause additional damage of devices on the wafer.

### BRIEF DESCRIPTION OF THE DRAWINGS

The present invention is illustrated by way of example, and not by way of limitation, in the figures of the accompanying drawings.

FIG. 1A is a schematic diagram illustrating one embodiment of an apparatus for cleaning a wafer.

FIG. 1B is a schematic diagram illustrating another embodiment of an apparatus for cleaning a wafer.

FIG. 2A is a schematic diagram illustrating another embodiment of an apparatus for cleaning a wafer.

FIG. 2B is a schematic diagram illustrating another embodiment of an apparatus for cleaning a wafer.

FIG. 3A is a schematic diagram illustrating another embodiment of an apparatus for cleaning a wafer.

FIG. 3B is a schematic diagram illustrating another embodiment of an apparatus for cleaning a wafer.

FIG. 4 is a flow diagram of a method for cleaning a wafer in accordance with one embodiment.

### DETAILED DESCRIPTION

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the spirit and scope of the present invention.

A method and apparatus for cleaning a wafer is described. The apparatus has a first chamber coupled to a first input to form de-ionized water droplets. A component is coupled to the first chamber to further atomize the de-ionized water droplets from the first chamber. The size of the droplets is reduced while the velocity of the droplets is increased.

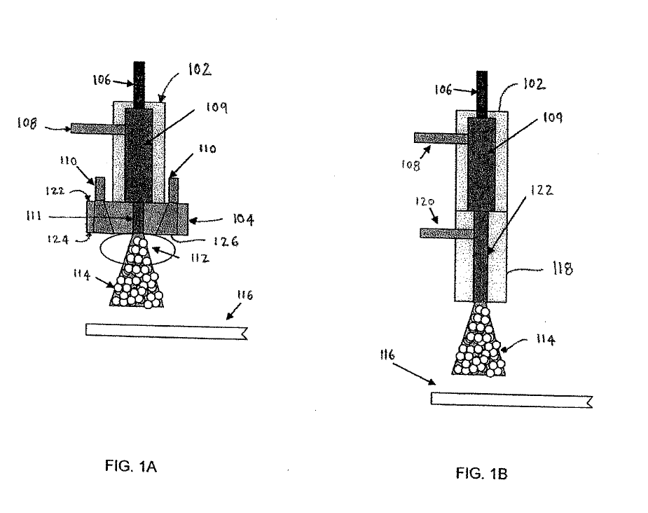

FIG. 1A is a schematic diagram illustrating one embodiment of an apparatus for cleaning a wafer. The apparatus has a first chamber 102 connected to a component. The first chamber 102 has a first input 106, and a second input 108. The first input 106 is adapted to receive a liquid such as de-ionized water from a source of de-ionized water (not shown).

In accordance with a second embodiment, the liquid may comprise a solution made of NH4OH+H2O2+DIW with respective concentrations from about 1:1:5 to about 1:1:100. In accordance with a third embodiment, the liquid may comprise a solution made of HCl+H2O2+DIW with respective concentration from about 1:1:5 to about 1:1:100. In accordance with a fourth embodiment, the liquid may comprise a solution made of diluted HF with respective concentration from about 1:10 to about 1:200.

The second input 108 is adapted to receive a gas, such as nitrogen from a source of nitrogen (not shown). The first chamber 102 has a mixing chamber 109 connected to both the first input 106 and the second input 108. In accordance with one embodiment, the nitrogen gas and the de-ionized water are introduced and mixed in the mixing chamber 109 at room temperature. Those of ordinary skills in the art will recognize that the nitrogen gas and the de-ionized water may be introduced and mixed at other different temperatures. The output of the mixing chamber 109 is connected to the component.

In accordance with one embodiment, the component may be a nozzle 104 having a main aperture 111. The main aperture 111 may be disposed in a central region of the nozzle 104. The main aperture 111 may be directly connected to the output of the mixing chamber 109.

The nozzle 104 may further include at least one inlet 110 adapted to received nitrogen from the source of nitrogen previously discussed. The inlets 110 may be disposed on a top surface 122 of the nozzle 104 adjacent and around to the first chamber 102. A corresponding number of outlets 126 may be disposed adjacent and around the main aperture 111 on a bottom surface 124 of the nozzle 104. The outlets 126 may each have an opening that is larger and wider than the opening of the corresponding inlets 110.

The nitrogen gas output by the outlets 126 mix with the output of the main aperture 111 at an external mixing region 112 outside the nozzle 104 to generate de-ionized water droplets 114, each droplet having a further smaller size. The external mixing region 112 may be below the nozzle 104 and above the surface of a wafer 116.

FIG. 1A illustrates one embodiment of the apparatus with a two-stage atomization of the de-ionized water. The first stage may occur within the first chamber 102. The second stage may occur outside of the nozzle 104. Those of ordinary skills in the art will recognize that the present invention is not limited to two stages, but the apparatus may have only one stage or several stages to produce smaller droplet size with a faster droplet velocity so as to efficiently clean the wafer without damaging any features on the wafer. In accordance with one embodiment, each droplet may measure less than about 20 microns.

In accordance with another embodiment, the component may be a second chamber 118 having a second mixing chamber 122 as illustrated in FIG. 1B. The second mixing chamber 122 is connected to a third input 120 adapted to receive nitrogen from the source of nitrogen. The nitrogen from the third input 120 is mixed with the output of the mixing chamber 109 of the first chamber 102. In accordance with one embodiment, the output of the mixing chamber 109 and the nitrogen from the third input 120 are introduced and mixed in the mixing chamber 109 at room temperature. Those of ordinary skills in the art will recognize that the nitrogen gas and the de-ionized water droplets from the output of the first chamber 102 may be introduced and mixed at other different temperatures. The output of the second chamber 118 generates de-ionized water droplets 114 directed to the top surface of the wafer 116.

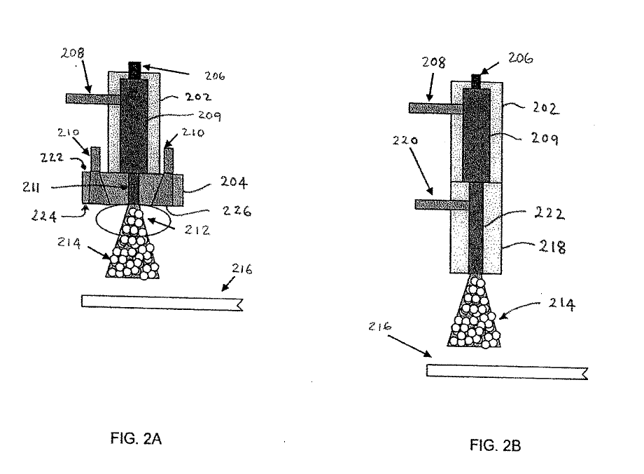

FIG. 2A is a schematic diagram illustrating one embodiment of an apparatus for cleaning a wafer. The apparatus has a first chamber 202 connected to a component. The first chamber 202 has a mixing chamber 209 connected to a first input 208 and a megasonic transducer 206.

The first input 208 is adapted to receive a liquid, such as de-ionized water from a source of de-ionized water (not shown). In accordance with a second embodiment, the liquid may comprise a solution made of NH4OH+H2O2+DIW with respective concentrations from about 1:1:5 to about 1:1:100. In accordance with a third embodiment, the liquid may comprise a solution made of HCl+H2O2+DIW with respective concentration from about 1:1:5 to about 1:1:100. In accordance with a fourth embodiment, the liquid may comprise a solution made of diluted HF with respective concentration from about 1:10 to about 1:200.

The megasonic transducer 206 produces vibrations at a high frequency to atomize the de-ionized water from the first input 208. The megasonic transducer 206 may be attached to a top of the mixing chamber 209.

In accordance with one embodiment, the de-ionized water is introduced and mixed in the mixing chamber 209 at room temperature. Those of ordinary skills in the art will recognize that the de-ionized water may be introduced and mixed at other different temperatures. The output of the mixing chamber 209 is connected to the component.

In accordance with one embodiment, the component may be a nozzle 204 having a main aperture 211. The main aperture 211 may be disposed in a central region of the nozzle 204. The main aperture 211 may be directly connected to the output of the mixing chamber 209.

The nozzle 204 may further include at least one inlet 210 adapted to received nitrogen from a source of nitrogen. In accordance with one embodiment, the nitrogen may be at room temperature. However, the nitrogen may be also at other temperatures besides room temperature. The inlets 210 may be disposed on a top surface 222 of the nozzle 204 adjacent and around to the first chamber 202. A corresponding number of outlets 226 may be disposed adjacent and around the main aperture 211 on a bottom surface 224 of the nozzle 204.

The nitrogen gas output by the outlets 226 mix with the output of the main aperture 211 at an external mixing region 212 outside the nozzle 204 to generate de-ionized water droplets 214, each droplet having a further smaller size. The external mixing region 212 may be below the nozzle 204 and above the surface of the wafer 216.

FIG. 2A illustrates one embodiment of the apparatus with a two-stage atomization of the de-ionized water. The first stage may occur within the first chamber 202. The second stage may occur outside of the nozzle 204. Those of ordinary skills in the art will recognize that the present invention is not limited to two stages, but the apparatus may have only one stage or several stages to produce smaller droplet size with a faster droplet velocity so as to efficiently clean the wafer without damaging any features on the wafer.

In accordance with another embodiment, the component may be a second chamber 218 having a second mixing chamber 222 as illustrated in FIG. 2B. The second mixing chamber 222 is connected to a second input 220 adapted to receive nitrogen from the source of nitrogen. The nitrogen from the second input 220 is mixed with the output of the mixing chamber 209 of the first chamber 202. In accordance with one embodiment, the output of the mixing chamber 209 and the nitrogen from the second input 220 are introduced and mixed in the mixing chamber 222 at room temperature. Those of ordinary skills in the art will recognize that the nitrogen gas and the de-ionized water droplets from the output of the first chamber 202 may be introduced and mixed at other different temperatures. The output of the second chamber 218 generates de-ionized water droplets 214 directed to the top surface of the wafer 216.

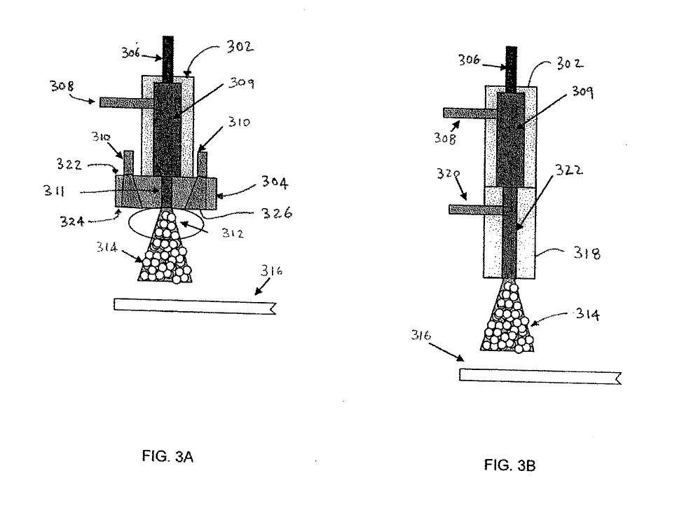

FIG. 3A is a schematic diagram illustrating one embodiment of an apparatus for cleaning a wafer. The apparatus has a first chamber 302 connected to a component. The first chamber 302 has a first input 306, and a second input 308. The first input 306 is adapted to receive hot de-ionized water steam. The second input 308 is adapted to receive a gas, such as nitrogen from a source of nitrogen (not shown). The first chamber 302 has a mixing chamber 309 connected to both the first input 306 and the second input 308. In accordance with one embodiment, the nitrogen gas and the hot de-ionized water steam are introduced and mixed in the mixing chamber 309 at room temperature. Those of ordinary skills in the art will recognize that the nitrogen gas and the de-ionized water may be introduced and mixed at other different temperatures. The output of the mixing chamber 309 is connected to the component.

In accordance with one embodiment, the component may be a nozzle 304 having a main aperture 311. The main aperture 311 may be disposed in a central region of the nozzle 304. The main aperture 311 may be directly connected to the output of the mixing chamber 309.

The nozzle 304 may further include at least one inlet 310 adapted to received nitrogen from the source of nitrogen previously discussed. The inlets 310 may be disposed on a top surface 322 of the nozzle 304 adjacent and around to the first chamber 302. A corresponding number of outlets 326 may be disposed adjacent and around the main aperture 311 on a bottom surface 324 of the nozzle 304.

The nitrogen gas output by the outlets 326 mix with the output of the main aperture 311 at an external mixing region 312 outside the nozzle 304 to generate de-ionized water droplets 314, each droplet having a further smaller size. The external mixing region 312 may be below the nozzle 304 and above the surface of the wafer 316.

FIG. 3A illustrates one embodiment of the apparatus with a two-stage atomization of the de-ionized water. The first stage may occur within the first chamber 302. The second stage may occur outside of the nozzle 304. Those of ordinary skills in the art will recognize that the present invention is not limited to two stages, but the apparatus may have only one stage or several stages to produce smaller droplet size with a faster droplet velocity so as to efficiently clean the wafer without damaging any features on the wafer.

In accordance with another embodiment, the component may be a second chamber 318 having a second mixing chamber 322 as illustrated in FIG. 3B. The second mixing chamber 322 is connected to a third input 320 adapted to receive nitrogen from the source of nitrogen. The nitrogen from the third input 320 is mixed with the output of the mixing chamber 309 of the first chamber 302. In accordance with one embodiment, the output of the mixing chamber 309 and the nitrogen from the third input 320 are introduced and mixed in the mixing chamber 309 at room temperature. Those of ordinary skills in the art will recognize that the nitrogen gas and the de-ionized water droplets from the output of the first chamber 302 may be introduced and mixed at other different temperatures. The output of the second chamber 318 generates de-ionized water droplets 314 directed to the top surface of the wafer 316.

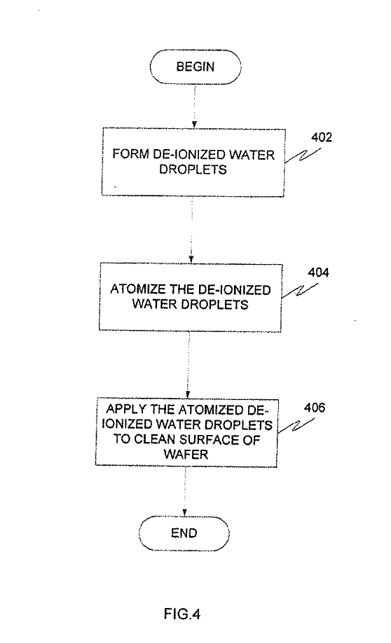

FIG. 4 is a flow diagram of a method for cleaning a wafer in accordance with one embodiment. At 402, de-ionized water droplets are formed via various means as previously described. At 404, the de-ionized water droplets are further atomized to reduce the size of the droplets and to increase the velocity of the droplets.

The kinetic energy of the droplets may be expressed with the following equation:

Eₖ=½×m×v²

wherein Eₖ is the Kinetic Energy, m is the mass of the droplet, and v is velocity of the droplet.

The Power density of the droplets may be expressed with the following equation:

P=Eₖ×(Q/(⅙×Pi×d³))

wherein Q is the volume flux.

Thus, the power density can be maintained by reducing the size of the droplets and increasing the velocity of the droplets. The smaller droplets size prevents any line damages to the wafer. The faster droplets efficiently clean the wafer without damaging its surface.

At 406, the smaller and faster de-ionized water droplets are applied to the surface of a wafer to clean the wafer.

In accordance with another embodiment, a surface tension reducing agent, such as a surfactant, may be used to reduce the de-ionized water surface tension, so that nitrogen mixing can fully atomize the de-ionized water.

In accordance with another embodiment, the de-ionized water supplied to the first chamber can be heated to reduce the de-ionized water surface tension, so that nitrogen mixing can fully atomize the de-ionized water.

In accordance with another embodiment, one or more of the above means for atomizing the de-ionized water can be combined to produce de-ionized water droplets of a smaller size.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. An apparatus for cleaning a wafer comprising:
a first chamber coupled to a first input to form droplets; and
a component coupled to the first chamber to further atomize the droplets.

2. The apparatus of claim 1, wherein the first chamber comprises:
a second input coupled to a source of nitrogen;
a mixing chamber coupled to the first input and the second input,
wherein the first input is coupled to a source of liquid.

3. The apparatus of claim 2, wherein the liquid comprises de-ionized water.

4. The apparatus of claim 2, wherein the liquid comprises NH4OH, H2O2, and de-ionized water.

5. The apparatus of claim 2, wherein the liquid comprises HCl, H2O2, and de-ionized water.

6. The apparatus of claim 2, wherein the liquid comprises diluted HF.

7. The apparatus of claim 2, wherein the component comprises:
at least one inlet coupled to the source of nitrogen; and
a nozzle coupled to the at least one inlet and an output of the mixing chamber to form an external mixing area at the output of the nozzle.

8. The apparatus of claim 2, wherein the component comprises:
a second chamber coupled to an output of the mixing chamber; and
an input of the second chamber coupled to the source of nitrogen to further atomize the droplets.

9. The apparatus of claim 1, wherein the first chamber comprises:
a mixing chamber coupled to the first input, the first input coupled to a source of liquid; and
a megasonic transducer coupled the mixing chamber to form the droplets.

10. The apparatus of claim 9, wherein the liquid comprises de-ionized water.

11. The apparatus of claim 9, wherein the liquid comprises NH4OH, H2O2, and de-ionized water.

12. The apparatus of claim 9, wherein the liquid comprises HCl, H2O2, and de-ionized water.

13. The apparatus of claim 9, wherein the liquid comprises diluted HF.

14. The apparatus of claim 9, wherein the component comprises:
at least one inlet coupled to a source of nitrogen; and
a nozzle coupled to the at least one inlet and an output of the mixing chamber to form an external mixing area at the output of the nozzle.

15. The apparatus of claim 9, wherein the component comprises:
a second chamber coupled to an output of the mixing chamber; and
an input of the second chamber coupled to the source of nitrogen to further atomize the de-ionized water droplets.

16. The apparatus of claim 1, wherein the first chamber comprises:
a second input coupled to a source of nitrogen;
a mixing chamber coupled to the first input and the second input,
wherein the first input is coupled to a source of hot water steam.

17. The apparatus of claim 16, wherein the component comprises:
at least one inlet coupled to the source of nitrogen; and
a nozzle coupled to the at least one inlet and an output of the mixing chamber to form an external mixing area at the output of the nozzle.

18. The apparatus of claim 16, wherein the component comprises:
a second chamber coupled to an output of the mixing chamber; and
an input of the second chamber coupled to the source of nitrogen to further atomize the droplets.

19. The apparatus of claim 1, wherein the droplets from the first chamber are larger than the droplets from the second chamber, and the velocity of the droplets output from the second chamber is higher than the velocity of the droplets output from the first chamber, and the droplets output from the second chamber is applied to a surface of the wafer.

20. A method for cleaning a wafer comprising:
forming droplets; and
atomizing the droplets.

21. The method of claim 20, further comprising:
applying the atomized droplets to a surface of the wafer.

22. The method of claim 21, further comprising:
spraying the atomized droplets to the surface of the wafer in a sweeping pattern.

23. The method of claim 20, wherein atomizing further comprises:
reducing the size of the droplets; and
increasing the velocity of the droplets.

24. The method of claim 20, wherein forming droplets further comprises:
mixing a liquid with nitrogen gas.

25. The method of claim 24, wherein the liquid comprises de-ionized water.

26. The method of claim 24, wherein the liquid comprises NH4OH, H2O2, and de-ionized water.

27. The method of claim 24, wherein the liquid comprises HCl, H2O2, and de-ionized water.

28. The method of claim 24, wherein the liquid comprises diluted HF.

29. The method of claim 20, wherein forming droplets further comprises:
applying a megasonic transducer to the droplets.

30. The method of claim 20, wherein forming droplets further comprises:
mixing hot water steam with nitrogen gas.

31. The method of claim 20, wherein atomizing further comprises:
mixing nitrogen gas with the droplets in a chamber.

32. The method of claim 20, wherein atomizing further comprises:
mixing nitrogen gas with the droplets outside a chamber.
